(19) United States
(12) Patent Application Publication
(10) Pub. No.: US 2004/0030555 A1
(43) Pub. Date: Feb. 12, 2004

(54) System and method for concatenating acoustic contours for speech synthesis

(75) Inventor: Jan P.H. van Santen, Lake Oswego, OR (US)

Correspondence Address: DARBY & DARBY P.C., Post Office Box 5257, New York, NY, 10150-5257, US

(73) Assignee: Oregon Health & Science University

(21) Appl. No.: 10/217,793

(22) Filed: Aug. 12, 2002

(51) Int. Cl. G10L 13/08

(52) U.S. Cl. 704/260

(57) ABSTRACT

A system and method for automatically computing pitch contours from a symbolic input, such as text that closely mimics pitch contours in natural speech. The method of the invention comprises estimating component contours, such as “phrase contours” and “accent contours”, from natural speech recordings. The phrase contours are associated with certain sequences of syllables, such as “feet”, or “accent groups.” A natural pitch contour is modeled as a mathematical combination. During synthesis, stored natural speech intervals are retrieved along with the corresponding accent curves. A temporal manipulation of the speech intervals performed by the synthesis algorithms, such as shortening or lengthening algorithms, is identically applied to the corresponding accent curves. The final output pitch contour is generated by mathematically combining (e.g., adding) the temporally manipulated accent curves to a phrase curve.

### BACKGROUND OF THE INVENTION

1. Field of the Invention

The invention generally relates to the field of speech synthesis and, more particularly, to a system and method for concatenating acoustic contours for speech synthesis.

2. Description of the Related Art

Concatenative speech synthesis is used for various types of speech synthesis applications including text-to-speech and voice recognition systems. Most text-to-speech conversion systems convert an input text string into a corresponding string of linguistic units such as consonants and vowel phonemes, or phoneme variants such as allophones, diphones, or triphones. An allophone is a variant of the phoneme based on surrounding sounds. For example, the aspirated p of the word pawn and the unaspirated p of the word spawn are both allophones of the phoneme p. Phonemes are the basic building blocks of speech corresponding to the sounds of a particular language or dialect. Diphones and triphones are sequences of phonemes and are related to allophones in that the pronunciation of each of the phonemes depend on the other phonemes, diphones or triphones.

Diphone synthesis and acoustic unit selection synthesis (concatenative speech synthesis) are two categories of speech synthesis techniques which are frequently used today. Concatenative speech synthesis techniques involve concatenating diphone phonetic sequences obtained from recorded speech to form new words and sentences. Such concatenative synthesis uses actual pre-recorded speech to form a large database, or corpus which is segmented based on phonological features of a language. Commonly, the phonological features include transitions from one phoneme to at least one other phoneme. For instance, the phonemes can be segmented into diphone units, syllables or even words.

A diphone is an acoustic unit that extends from the middle of one phoneme to the middle of the next phoneme. In other words, the diphone includes the transition between each partial phoneme. It is generally believed that synthesis using concatenation of diphones provides a reproduced voice of high quality, since each diphone is concatenated with adjoining diphones at the point where the beginning and the ending phonemes have reached steady state, and since each diphone records the actual transition from phoneme to phoneme.

In diphone synthesis, a diphone is defined as the second half of one phoneme followed by the initial half of the following phoneme. At the cost of having N.times.N (capital N being the number of phonemes in a language or dialect) speech recordings, i.e., diphones in a database, high quality synthesis can be achieved. For example, in English, N would equal between 40-45 phonemes depending on regional accents and the definition of the phoneme set. Here, an appropriate sequence of diphones is concatenated into one continuous signal using a variety of techniques (e.g., time-domain Pitch Synchronis Overlap and Add (TD-PSOLA)).

This approach does not, however, completely solve the problem of providing smooth concatenations, nor does it solve the problem of generating natural sounding synthetic speech. Generally, there is some spectral envelope mismatch at the concatenation boundaries. For severe cases, depending on how the signals are treated, a speech signal may exhibit glitches, or degradation in the clarity of the speech signal may occur. Consequently, a great deal of effort is often expended to choose appropriate diphone units that will not possess such defects, irrespective of which other units they are matched with. Thus, in general, a considerable effort is devoted to preparing a diphone set and selecting sequences that are suitable for recording and to verifying that the recordings are suitable for the diphone set.

In addition to the foregoing problems, other significant problems exist in conventional diphone concatenation systems. In order to achieve a suitable concatenation system, a minimum of 1500 to 2000 individual diphones must be used. When segmented from pre-recorded continuous speech, suitable diphones may be unobtainable because many phonemes (where concatenation is to take place) have not reached a steady state. Thus, a mismatch or distortion can occur from phoneme to phoneme at the point where the diphones are concatenated together. To reduce this distortion, conventional diphone concatenative synthesizers, as well as others, often select their units from carrier sentences or monotone speech and/or often perform spectral smoothing. As a result, a decrease in the naturalness of the speech can occur. Consequently, the synthesized speech may not resemble the original speech.

Another approach to concatenative synthesis is unit selection synthesis. Here, a very large database for recorded speech that has been segmented and labeled with prosodic and spectral characteristics is used, such as the fundamental frequency (F₀) for voiced speech, the energy or gain of the signal, and the spectral distribution of the signal (i.e., how much of the signal is present at any given frequency). The database contains multiple instances of phoneme sequences. This permits the possibility of having units in the database that are much less stylized than would occur in a diphone database where generally only one instance of any given diphone is assumed. As a result, the ability to achieve natural sounding speech is enhanced.

For high quality speech synthesis, this technique relies on the ability to select units from the database, currently only phonemes or a string of phonemes, that are close in character to the prosodic specification provided by the speech synthesis system, and that have a low spectral mismatch at the concatenation points. The “best” sequence of units is determined by associating a numerical cost in two different ways. First, a cost (target cost) is associated with the individual units (in isolation) so that a lower cost results if the unit approximately possesses the desired characteristics, and a higher-cost results if the unit does not resemble the required unit. A second cost (concatenation cost) is associated with how smoothly units are joined together. Consequently, if the spectral mismatch is bad, then a high cost occurs, and if the spectral mismatch is low, a low cost occurs.

Thus, a set of candidate units for each position in the desired sequences (with associated costs), and a set of costs associated with joining anyone to its neighbors, is generated. This constitutes a network of nodes (with target costs) and links (with concatenation costs). Estimating the best (lowest-cost) path through the network is performed via a technique called Viterbi search. The chosen units are then concatenated to form one continuous signal using a variety of known techniques.

This technique permits synthesis which may sound very natural at times, but more often than not will sound very poor. In fact, using this technique intelligibility can be lower than for diphone synthesis. In most instances, phoneme boundaries are not the best place to try to concatenate two segments of speech. As a result, it is necessary to perform extensive searches to locate suitable concatenation points for this technique to work adequately, even after the selection of the individual acoustic units.

A key goal in the art of speech synthesis is to generate synthesized speech which sounds as human-like as possible. Thus, the synthesized speech must include appropriate pauses, inflections, accentuation and syllabic stress. In other words, for speech synthesis systems to provide a high quality of synthesized speech for non-trivial input textual speech that is as human-like as possible, such systems must be able to correctly pronounce the “words” read, to appropriately emphasize some words and de-emphasize others, to “chunk” a sentence into meaningful phrases, to pick an appropriate pitch contour, and to establish the duration of each phonetic segment or phoneme. Broadly speaking, such a system will operate to convert input text into some form of linguistic representation that includes information on the phonemes to be produced, their duration, the location of any phrase boundaries and the pitch contour to be used. This linguistic representation of the underlying text can then be converted into a speech waveform.

With particular respect to the pitch contour parameter, it is well known that good intonation, or pitch, is essential for synthesized speech to sound natural. Conventional speech synthesis systems can approximate the pitch contour. However, these systems are generally unable to achieve the natural sounding quality of the emulated style of speech.

It is well known that the computation of a natural intonation (pitch) contour from text for subsequent use by a speech synthesizer is a highly complex undertaking. An important reason for this complexity is that it is insufficient to specify only that the contour with respect to an emphasized syllable must reach a predetermined high value. Instead, the synthesizer process must recognize and deal with the fact that the exact height and temporal structure of a contour depend on the number of syllables in a speech interval, the location of the stressed syllable and the number of phonemes in the syllable, and in particular on their durations and voicing characteristics. Failure to appropriately deal with these pitch factors will result in synthesized speech that fails to adequately approach the human-like quality desired for such speech.

Traditionally, two method are used to generate an appropriate intonation (pitch, F₀). In the first method, such as the “traditional method”, a rule generated synthetic intonation contour is imposed by way of complicated signal modification algorithms. In the second method, such a “corpus based method”, a large speech corpus is labeled in terms of intonationally relevant tags, such as “stressed” or “sentence-final”; at run time, appropriate speech intervals are retrieved and concatenated, where the intonation of the speech is unaltered.

The problem with the traditional method is that the synthetic intonation contours are not natural. In fact, they may deviate sharply from the original intonation. Signal processing also introduces audible distortions when the amount of pitch modification is large. The problem with the corpus based method is that the number of possible combinations in any specific language is large. As a result, within a specific context, it is not possible to always determine the correct phoneme sequence. Hence, into national discontinuities or meaningless intonations occur. In addition, it is not possible to change the prosody such that different stress levels are reflected without incurring a further growth of the size of the corpus.

A common problem with the concatenation of natural speech is that the pitch contours of the concatenated intervals are inconsistent due to natural sentence-to-sentence variations of the original speaker. These inconsistencies are perceived as erratic, singsong like, and as placing inappropriate emphasis on words.

Computer speech can be generated by text-to-speech (TTS) systems or by word and phrase concatenation systems. Speech produced by either technology is often characterized by poor intonation. Word and phrase concatenation systems can produce undesired pitch discrepancies between words in the output. TTS systems can, in addition to these discrepancies, have additional problems such as within-word intonation that is unnatural. This unnaturalness can occur either as a result of within-word discrepancies or as a result of poorly computed within-word artificial contours. An example of the latter would be a triangular up-down pitch movement; no such movements occur in natural speech, where up-down movements are much smoother. An additional example is that natural pitch contours are locally not smooth. Successive pitch periods fluctuate in duration (“jitter”), and also exhibit natural irregularities such as creaking, where the pitch period suddenly doubles in duration. Current TTS technology is unable to mimic these natural speech phenomena, which further adds to the unnaturalness of speech generated by these systems.

Accordingly, it is apparent that there is a need for a method for removing undesired pitch discrepancies between words in the output from word and phrase concatenation systems and to enhance the naturalness of intonation of speech generated by TTS systems.

### SUMMARY OF THE INVENTION

The invention is a system and method for automatically computing pitch contours from a symbolic input, such as text that closely represents pitch contours in natural speech. The method of the invention comprises estimating component contours, such as “phrase contours,” “accent contours,” and “residual contours” from natural speech recordings. Here, the phrase contours are associated with certain sequences of syllables, such as “feet”, or “accent groups.” In accordance with the invention, a natural pitch contour is modeled as a mathematical combination and stored for use during synthesis of speech. In preferred embodiments, the mathematical combination is performed by way of addition of the estimated component curves.

During speech synthesis, stored natural speech intervals are retrieved along with corresponding accent curves. A temporal manipulation of the speech intervals performed by the synthesis algorithms, such as shortening or lengthening algorithms, is identically applied to the corresponding accent curves and residual contours. The final output pitch contour is generated by mathematically combining (e.g., adding) the temporally manipulated accent curves to a phrase curve.

The method of the invention permits the removal of undesired pitch discrepancies between words output from word and phrase concatenation systems. In addition, the naturalness of the intonations in speech generated by TTS systems is enhanced.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an illustration of a schematic block diagram of an exemplary text-to-speech synthesizer employing an acoustic element database in accordance with the present invention;

FIGS. 2(a) through 2(c) is an illustration of speech spectograms of exemplary formants of a phonetic segment;

FIG. 3 is a phonetic and an orthographic illustration of classes for each phoneme within the English language;

FIG. 4 is an exemplary graphical plot of an original pitch contour in accordance with the invention;

FIG. 5 is an exemplary graphical plot of an estimated original pitch contour in accordance with the invention;

FIG. 6 is an illustration of an exemplary phrase curve of the pitch contour of FIG. 4;

FIG. 7 an exemplary graphical plot of an accent curve of the pitch contour of FIG. 4;

FIG. 8 is an exemplary graphical plot of a residuals curve of the pitch contour of FIG. 4;

FIG. 9 is an exemplary graphical plot of an estimated phrase curve that represents the phrase curve of FIG. 6;

FIG. 10 is an exemplary graphical plot of an estimated accent curve that represents the accent curve of FIG. 7;

FIG. 11 is an exemplary graphical plot of an estimated residuals curve that represents the residuals curve of FIG. 8;

FIGS. 12(a)-12(c) is a flow chart illustrating the steps of the method of the invention for concatenating acoustic contours in accordance with the invention; and

FIGS. 13(a)-13(c) is an illustration of the steps for concatenating speech in a text-to-speech system in accordance with further aspect of the invention.

### DETAILED DESCRIPTION OF THE PREFERRED EMBODIMENTS

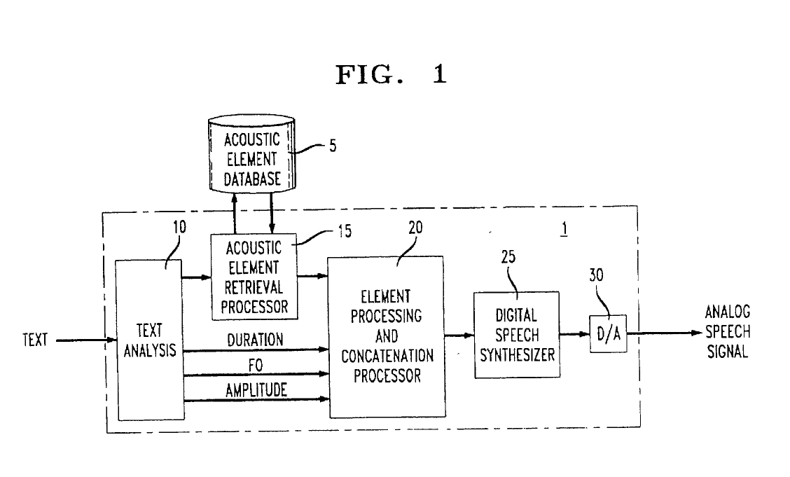

An exemplary text-to-speech synthesizer 1 for concatenating acoustic contours for speech synthesis in accordance with the present invention is shown in FIG. 1. For clarity, functional components of the text-to-speech synthesizer 1 are represented by boxes in FIG. 1. The functions executed in these boxes can be provided through the use of either shared or dedicated hardware including, but not limited to, application specific integrated circuits, or a processor or multiple processors executing software. Use of the term processor and forms thereof should not be construed to refer exclusively to hardware capable of executing software and can be respective software routines performing the corresponding functions and communicating with one another.

In FIG. 1, it is possible for the database 5 to reside on a storage medium such as computer readable memory including, for example, a CD-ROM, floppy disk, hard disk, read-only-memory (ROM) and random-access-memory (RAM). The database 5 contains acoustic elements corresponding to different phoneme sequences or polyphones including allophones.

In order for the database 5 to be of modest size, the acoustic elements should generally correspond to a limited sequences of phonemes, such as one to three phonemes. The acoustic elements are phonetic sequences that start in the substantially steady-state center of one phoneme and ends in the steady-state center of another phoneme. It is possible to store the acoustic elements in the database 5 in the form of linear predictive coder (LPC) parameters or digitized speech which are described in detail in, for example, J. Olive et al. “Multilingual Text-to-Speech Synthesis: The Bell Labs Approach, Synthesis.” R. Sproat Ed., pgs. 191-228 (Kluwer, Dordrecht. 1998), which is incorporated by reference herein.

The text-to-speech synthesizer 1 includes a text analyzer 10, acoustic element retrieval processor 15, element processing and concatenation (EPC) processor 20, digital speech synthesizer 25 and digital-to-analog (D/A) converter 30. The text analyzer 10 receives text in a readable format, such as ASCII format, and parses the text into words and further converts abbreviations and numbers into words. The words are then separated into phoneme sequences based on the available acoustic elements in the database 5. These phoneme sequences are then communicated to the acoustic element retrieval processor 15.

Exemplary methods for the parsing of words into phoneme sequences and the abbreviation and number expansion are described in J. Olive et al. “Progress in Speech Synthesis: Language-independent data-oriented grapheme conversion.” pgs 77-79, (Springer New York. 1996); M. Horne et al. “Computational Extraction of Lexico-Grammatical Information for generation of Swedish Intonation.” Proceedings of the 2^{nd} ESCA/IEEE workshop on Speech Synthesis, pgs. 220-223, (New Paltz, N.Y. 1994); and in D. Yarowsky. “Homograph Disambiguation in Speech Synthesis.” Proceedings of the 2nd ESCA/IEEE workshop on Speech Synthesis, pgs. 244-247, (New Paltz, N.Y. 1994), all of which are incorporated by reference herein.

The text analyzer 10 further determines the duration, amplitude and fundamental frequency of each of the phoneme sequences and communicates such information to the EPC processor 20. Exemplary methods for determining the duration of a phoneme sequence include those described in J. van Santen “Assignment of Segmental Duration in Text-to-Speech Synthesis, Computer Speech and Language.” Vol. 8, pp. 95-128 (1994), which is incorporated by reference herein. Exemplary methods for determining the amplitude of a phoneme sequence are described in J. Olive et al. “Progress in Speech Synthesis: Text-to-Speech Synthesis with Dynamic Control of Source Parameters.” pgs. 27-39, (Springer, N.Y. 1996), which is also incorporated by reference herein. The fundamental frequency of a phoneme is alternatively referred to as the pitch or intonation of segment. Exemplary methods for determining the fundamental frequency or pitch of a phoneme are described in J. van Santen et al. “Segmental Effects on Timing and Height of Pitch Contours.” Proceedings of the International Conference on Spoken language Processing, pgs. 719-722 (Yokohama, Japan. 1994), which is further incorporated by reference herein.

The acoustic element retrieval processor 15 receives the phoneme sequences from the text analyzer 10 and then selects and retrieves the corresponding proper acoustic element from the database 5. Exemplary methods for selecting acoustic elements are described in the above cited Olive reference. The retrieved acoustic elements are then communicated by the acoustic element retrieval processor 15 to the EPC processor 20. The EPC processor 20 modifies each of the received acoustic elements by adjusting their fundamental frequency and amplitude, and inserting the proper duration based on the corresponding information received from the text analyzer 10. The EPC processor 20 then concatenates the modified acoustic elements into a string of acoustic elements corresponding to the text input of the text analyzer 10. Methods of concatenation for the EPC processor 20 are described in the above cited Oliveira article.

The string of acoustic elements generated by the EPC processor 20 is provided to the digital speech synthesizer 25 which produces digital signals corresponding to natural speech of the acoustic element string. Exemplary methods of digital speech synthesis are also described in the above cited Oliveira article. The digital signals produced by the digital speech synthesizer 25 are provided to the D/A converter 30 which generates corresponding analog signals. Such analog signals can be provided to an amplifier and loudspeaker (not shown) to produce natural sounding synthesized speech.

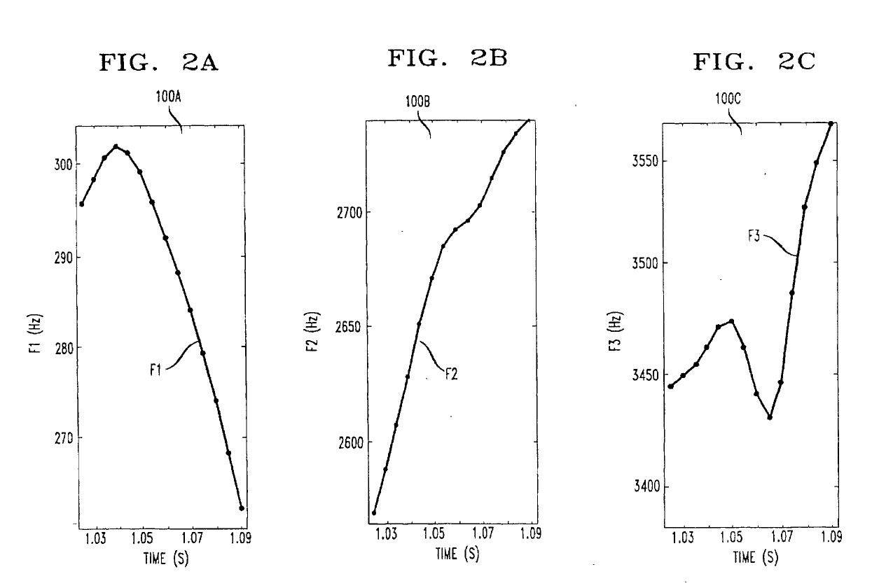

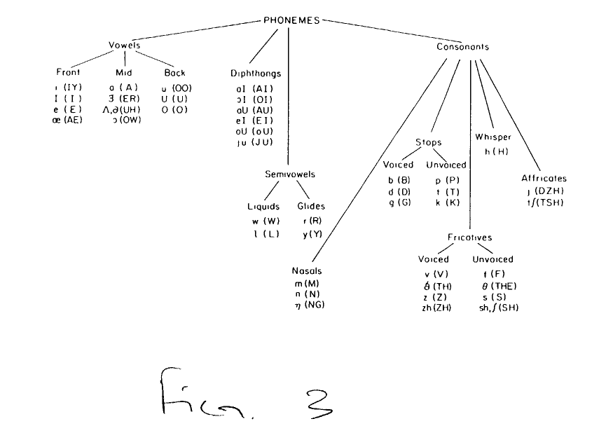

The characteristics of phonetic sequences over time can be represented in several representations including formants, amplitude and any spectral representations including ceptral representations or any LPC derived parameters. FIGS. 2A-2C show speech spectrograms 100A, 100B and 100C of different formant frequencies or formants F1, F2 and F3 for a phonetic segment corresponding to the phoneme /i/ taken from recorded speech of a phoneme sequence /p-i/. The formants F1-F3 are trajectories that depict the different measured resonance frequencies of the vocal tract of the human speaker. Formants for the different measured resonance frequencies are typically named F1, F2, . . . F_{N}, based on the spectral energy that is contained by the respective formants.

Formant frequencies depend upon the shape and dimensions of the vocal tract. Different sounds are formed by varying the shape of the vocal tract. Thus, the spectral properties of the speech signal vary with time as the vocal tract shape varies during the utterance of the phoneme segment /i/ as is depicted in FIGS. 2A-C. The three formants F1, F2 and F3 are depicted for the phoneme /i/ for illustration purposes only. It should be understood that different numbers of formants can exist based on the shape of the vocal tract for a particular speech segment. A more detailed description of formants and other representations of speech is provided in L. R. Rabiner and R. W. Schafer, Digital Processing of Speech Signals (Prentice-Hall, Inc., N.J., 1978), which is incorporated by reference herein.

Typically, the sounds of the English language are broken down into phoneme classes, as shown in FIG. 3. The four broad classes of sound are vowels, diphthongs, semivowels, and constants. Each of these classes may be further broken down into sub-classes related to the manner, and place of articulation of the sound within the vocal tract.

Each phoneme class in FIG. 3 can be classified as either a continuant or a non-continuant sound. Continuant sounds are produced by a fixed (on-time varying) vocal tract configuration excited by an appropriate source. The class of continuant sounds includes the vowels, fricatives (both voiced and unvoiced), and the nasals. The remaining sounds (dipthongs, semivowels stops and affricates) are produced by a changing vocal tract configuration. These are therefore classed as non-continuants.

Vowels are produced by exciting a fixed vocal tract with quasi-periodic pulses of air caused by vibration of the vocal cords of a speaker. Generally, the way in which the cross-sectional area along the vocal tract varies determines the resonant frequencies of the tract (formants) and thus the sound that is produced. The dependence of cross-sectional area upon distance along the tract is called the area function of the vocal tract. The area function for a particular vowel is determined primarily by the position of the tongue, but the positions of the jaw, lips, and, to a small extent, the velum also influence the resulting sound. For example, in forming the vowel /a/ as in “father,” the vocal tract is open at the front and somewhat constricted at the back by the main body of the tongue. In contrast, the vowel /i/ as in “eve” is formed by raising the tongue toward the palate, thus causing a constriction at the front and increasing the opening at the back of the vocal tract. Thus, each vowel sound can be characterized by the vocal tract configuration (area function) that is used in its production.

For the most part, a diphthong is a gliding monosyllabic speech item that starts at or near the articulatory position for one vowel and moves to or toward the position for another. In accordance with this, there are six diphthongs in American English including /eI/ (as in bay), /oU/ as in (boat), /aI/ (as in buy), /aU/ (as in how), /oI/ (as in b) and /ju/ (as in you). Diphthongs are produced by smoothly varying the vocal tract between vowel configurations appropriate to the diphthong. In general, the diphthongs can be characterized by a time varying vocal tract area function which varies between two vowel configurations.

The group of sounds consisting of /w/, /l/, /r/, and /y/ are called semivowels because of their vowel-like nature. They are generally characterized by a gliding transition in a vocal tract area function between adjacent phonemes. Thus the acoustic characteristics of these sounds are strongly influenced by the context in which they occur. For purposes of the contemplated embodiments, the semi-vowels are transitional, vowel-like sounds, and hence are similar in nature to the vowels and diphthongs. The semi-vowels consist of liquids (e.g., w l) and glides (e.g., y r), as shown in FIG. 3.

The nasal consonants /m/, /n/, and /η/ are produced with glottal excitation and the vocal tract totally constricted at some point along the oral passageway. The velum is lowered so that air flows through the nasal tract, with sound being radiated at the nostrils. The oral cavity, although constricted toward the front, is still acoustically coupled to the pharynx. Thus, the mouth serves as a resonant cavity that traps acoustic energy at certain natural frequencies. For /m/, the constriction is at the lips; for /n/ the constriction is just back of the teeth; and for /η/ the constriction is just forward of the velum itself.

The voiceless fricatives /ƒ/, /θ/, /s/ and /sh/ are produced by exciting the vocal tract with a steady air flow which becomes turbulent in the region of a constriction in the vocal tract. The location of the constriction serves to determine which fricative sound is produced. For the fricative /f/ the constriction is near the lips; for /θ/ it is near the teeth; for /s/ it is near the middle of the oral tract; and for /sh/ it is near the back of the oral tract. Thus, the system for producing voiceless fricatives consists of a source of noise at a constriction, which separates the vocal tract into two cavities. Sound is radiated from the lips, i.e., from the front cavity of the mouth. The back cavity serves, as in the case of nasals, to trap energy and thereby introduce anti-resonances into the vocal output.

The voiced fricatives /v/, /th/, /z/ and /zh/ are the respective counterparts of the unvoiced fricatives /θ/, /θ/, /s/, and /sh/, in that the place of constriction for each of the corresponding phonemes is essentially identical. However, voiced fricatives differ markedly from their unvoiced counterparts in that two excitation sources are involved in their production. For voiced fricatives the vocal cords are vibrating, and thus one excitation source is at the glottis. However, since the vocal tract is constricted at some point forward of the glottis, the air flow becomes turbulent in the neighborhood of the constriction.

The voiced stop consonants /b/, /d/ and /g/, are transient, non-continuant sounds which are produced by building up pressure behind a total constriction somewhere in the oral tract, and suddenly releasing the pressure. For /b/ the constriction is at the lips; for /d/ the constriction is back of the teeth; and for /g/ it is near the velum. During the period when there is a total constriction in the tract no sound is radiated from the lips. However, there is often a small amount of low frequency energy which is radiated through the walls of the throat (sometimes called a voice bar). This occurs when the vocal cords are able to vibrate even though the vocal tract is closed at some point.

The voiceless stop consonants /p/, /t/ and /k/ are similar to their voiced counterparts /b/, /d/, and /g/ with one major exception. During the period of total closure of the vocal tract, as the pressure builds up, the vocal cords do not vibrate. Thus, following the period of closure, as the air pressure is released, there is a brief interval of friction (due to sudden turbulence of the escaping air) followed by a period of aspiration (steady air flow from the glottis exciting the resonances of the vocal tract) before voiced excitation begins.

The remaining consonants of American English are the affricates /t∫/ and /j/ and the phoneme /h/. The voiceless affricate /t∫/ is a dynamical sound which can be modeled as the concatenation of the stop /t/ and the fricative /∫/. The voiced affricate /j/ can be modeled as the concatenation of the stop /d/ and the fricative /zh/. Finally, the phoneme /h/ is produced by exciting the vocal tract by a steady air flow, i.e., without the vocal cords vibrating, but with turbulent flow being produced at the glottis. Of note, this is also the mode of excitation of whispered speech. The characteristics of /h/ are invariably those of the vowel which follows /h/ since the vocal tract assumes the position for the following vowel during the production of /hl. See, e.g., L. R. Rabiner and R. W. Schafer, Digital Processing of Speech Signals (Prentice-Hall, Inc., N.J., 1978).

Many conventional speech synthesis systems utilize an acoustic inventory, i.e., a collection of intervals of recorded natural speech (e.g., acoustic units). These intervals correspond to phoneme sequences, where the phonemes are optionally marked for certain phonemic or prosodic environments. In embodiments of the invention, a phone is a marked or unmarked phoneme. Examples of such acoustic units include the /e/-/p/ unit (as in the words step or repudiate; in this unit, the constituent phones are not marked), the unstressed-/e/-stressed-/p/ unit (as in the word repudiate; both phones are marked for stress), or the final-/e/-final-/p/ unit (as in at the end of the phrase “He took one step;” both phones are marked since they occur in the final syllable of a sentence.) During synthesis, an algorithm is used to retrieve the appropriate sequence of units and concatenate them together to generate the output speech.

In contrast to U.S. Pat. No. 5,790,978 to Olive et al. entitled “System and method for determining pitch contours,” which describes a method for generating accent curves that uses rules and equations to generate an artificial accent curve, the invention is directed to the transformation of stored natural curves that are associated with stored speech intervals to generate accent curves for use in speech synthesis.

In accordance with the invention, identical temporal manipulations of the speech intervals are applied to a corresponding accent curve and the residuals curve. As a result, an original temporal synchrony between the fine spectral dynamics and the trajectory of the pitch contour is preserved. Generally, it is known that the duration of successive pitch epochs are somewhat random (“jitter”), and that there is a close relationship between the fundamental frequency of a speech interval and other spectral features, such as formant values and bandwidth. In conventional systems, and all existing systems that generate synthetic intonation contours by rule, the resulting pitch contours do not represent such epoch-by-epoch fluctuations. As a result, the quality of the output speech, when such contours are imposed on spectral dynamics originating from natural speech with jitter, may be adversely affected.

Certain natural speech utterances, such as prompts (e.g., “Welcome to XXX”), customarily possess an exaggerated pitch pattern that cannot be easily captured by known intonation models. In accordance with the invention, natural contours that are generated from such prompts are normalized by estimating component accent contours that are free of restrictions with respect to their shape, and combining the estimated accent contours with other similarly generated accent curves by adding the common phrase contours. Thus, the method of the invention permits a seamless combination of stored speech, or a seamless combination of stored speech and synthetic speech, while preserving subtle, yet perceptually critical, natural intonation features that are difficult to mathematically model.

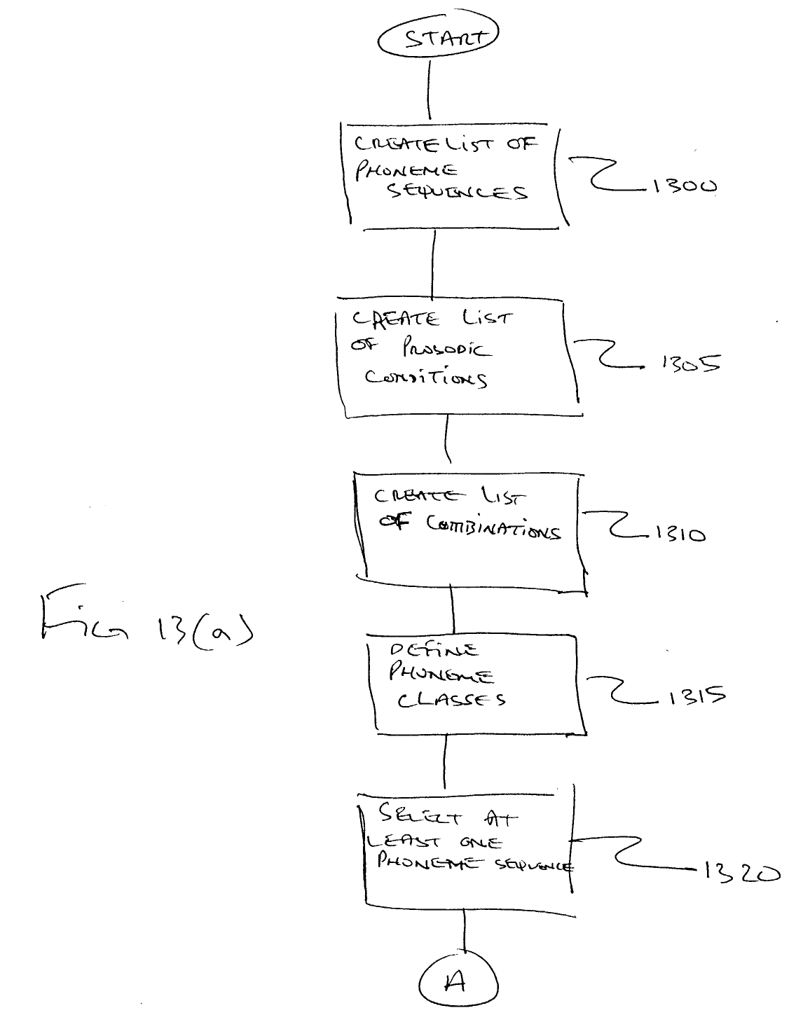

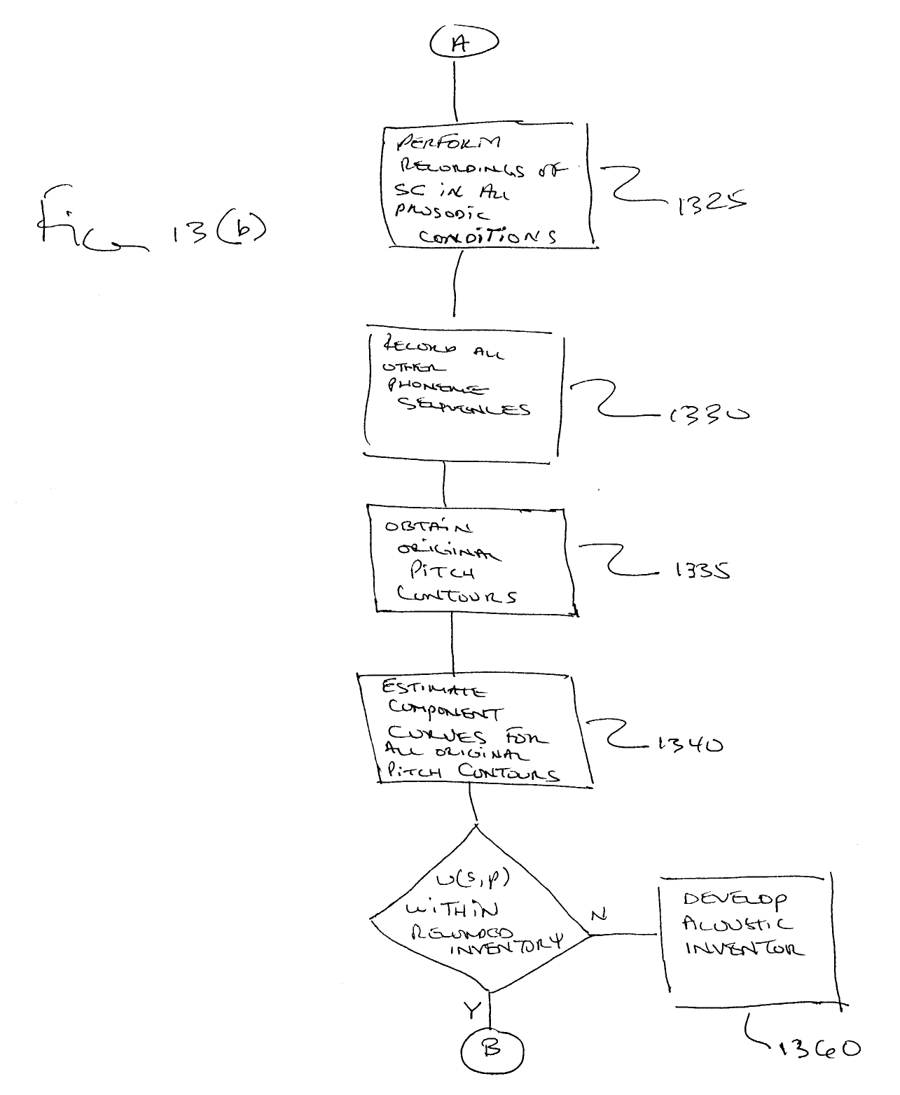

FIGS. 12(a)-12(c) is a flow chart illustrating the steps of the method of the invention. In accordance certain embodiments, the method for concatenating acoustic contours for speech synthesis is implemented by initially recording human speech, as indicated in step 1200. The recorded speech is then labeled with phoneme labels and time stamps, such as CSLU REF, and “prosodic tags”, such as ToBI REF, as indicated in step 1205. In this case, prosodic tags indicate the stress of syllables, emphasis levels and types of words, boundaries of phrases, and types of phrases, such as a “question”. In contemplated embodiments of the invention, a phrase is a sentence that is terminated by certain punctuation symbols, such as a period or a question mark. In other embodiments, a phrase is a sequence of words terminated by another punctuation, such as a comma, a phrase terminating symbol used by a text-to-speech system and/or a prosody markup scheme.

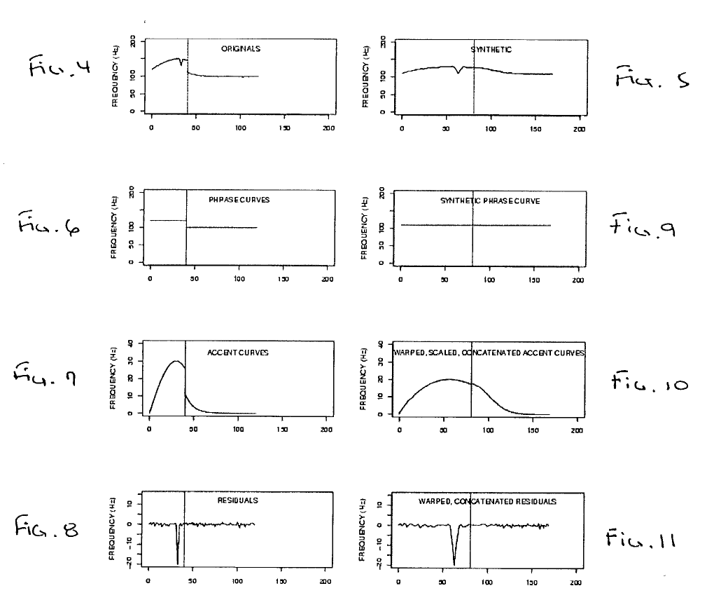

Next, original pitch contours ORIG(t) (see FIG. 4) are obtain by way of a pitch tracking algorithm, such as ESPS REF, as indicated in step 1210. Here, the original pitch contours have value that reside on a Hz scale and t denotes time. For each original pitch contour, a number of “component curves” are estimated, as indicated in step 1215. When the component curves (see FIG. 5) are combined, they closely approximate the original pitch contour (see FIG. 4). In the preferred embodiment, three component curves are estimated.

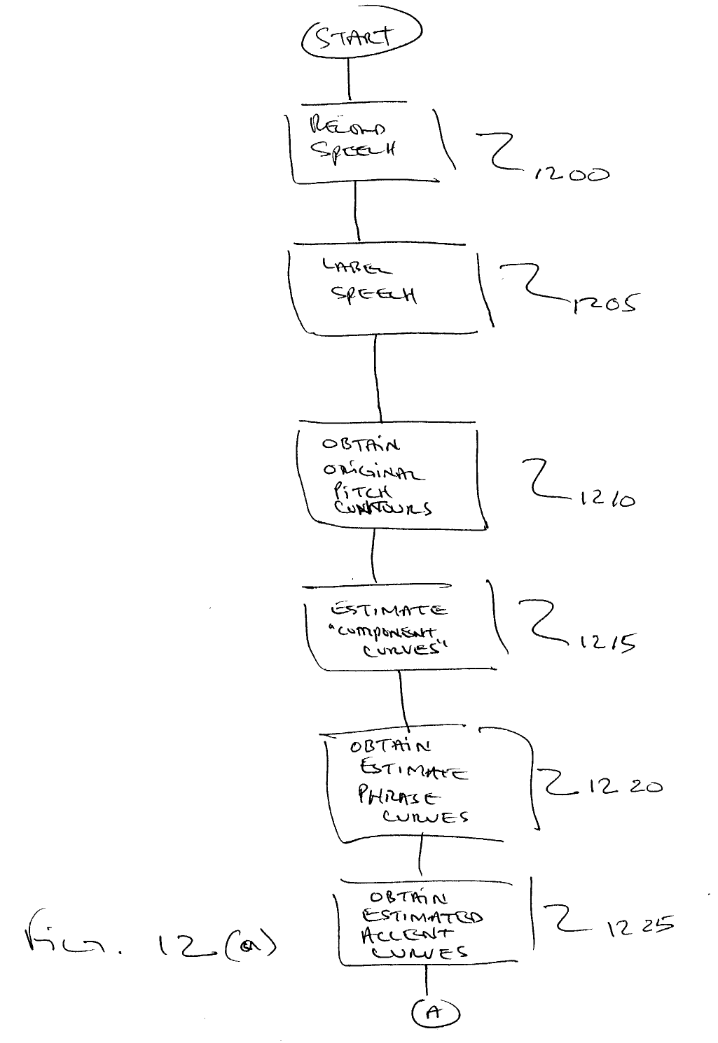

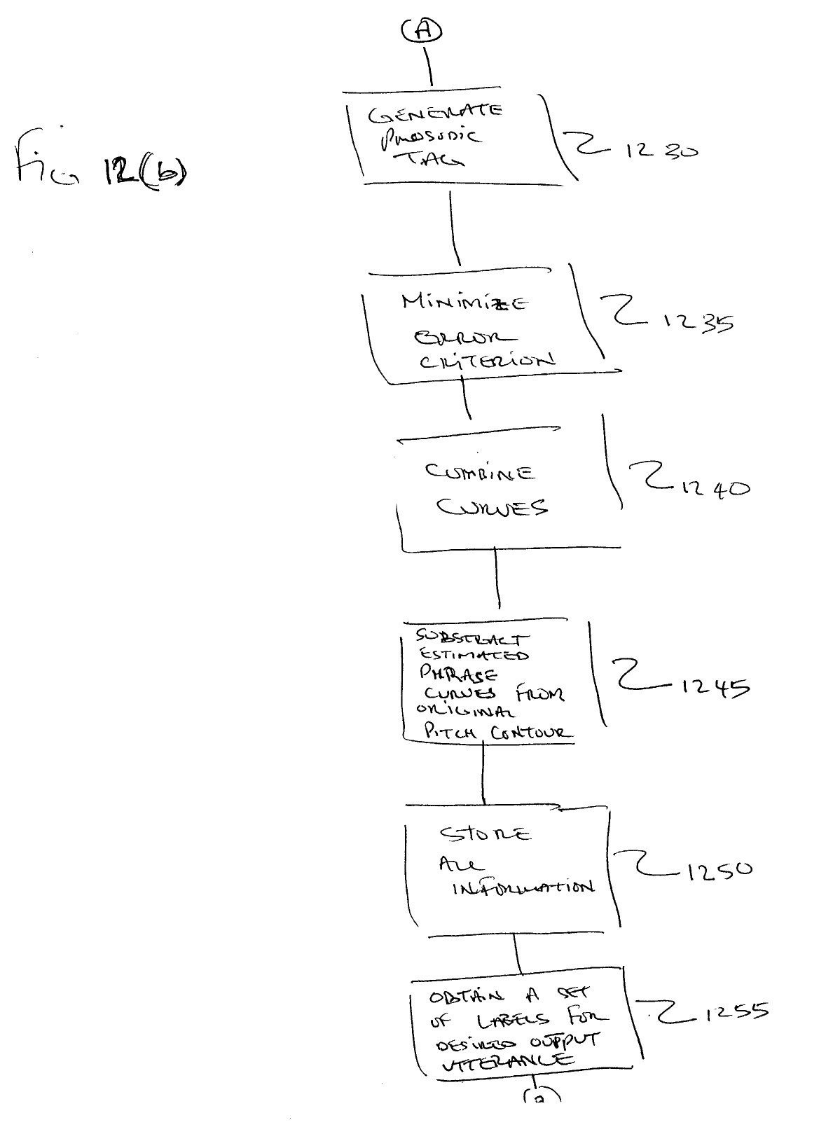

In contemplated embodiments of the invention, the combinational operation is a linear operation, a logarithmic operation or any other increasing transformation of pitch. In preferred embodiments, the combinational operation is generalized such that certain components of the component curves are “summed in” and other components are “multiplied in.” In contemplated embodiments, the component curves include a phrase curve (see FIG. 6), an accent curve (see FIG. 7), and residuals curves (see FIG. 8). Here, each phrase curve corresponds to a phrase, and a phrase curve is smooth in that it contains only a small number of “inflection points” that are points where the value of the second derivative of the component curve is zero or undefined. In preferred embodiments, the number of inflection points is no more than twice the number of stressed syllables in the phrase.

Next, estimated phrase curves PHRASE(t) (see FIG. 9) are obtained, as indicated in step 1220. Here, t in PHRASE(t) is time.

An example of such a phrase curve is shown in FIG. 9, and is obtained in accordance with the relationship:

PHRASE(t)=a₁t+b₁, if t1<=t<=t2, and a₂t+b₂, if t2<t<=t Eq. (1)

where a1 is an estimated slope and b1 a y-intercept.

As shown in FIG. 9, the parameters are computed such that the two straight lines intersect at a common point in a Time x Frequency space, (t1, f1). In accordance with the invention, the phrase curves are estimated by minimizing an “error criterion” E. (see estimation of accent curves discussed subsequently).

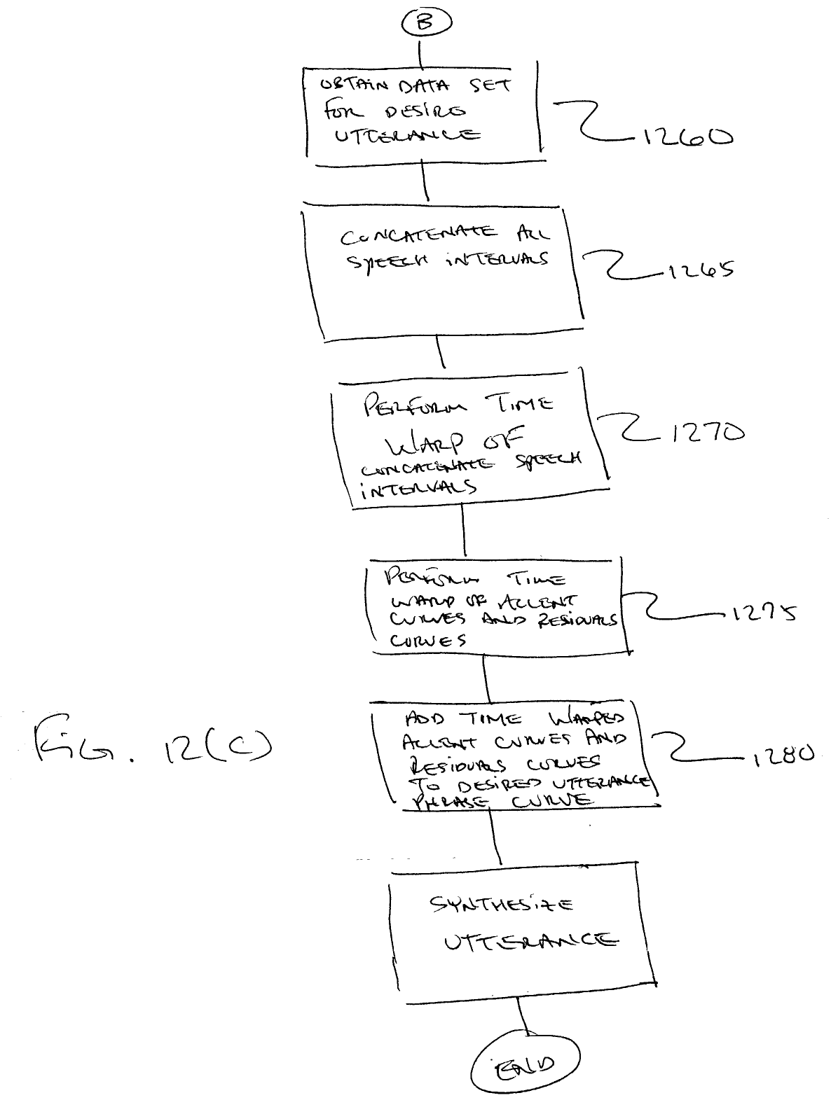

For a given phrase, an estimated accent curve ACCENTi(t) (see FIG. 10) is obtained, as indicate in step 1225. In contemplated embodiments, t in ACCENTi(t) is time and the accent curve corresponds to the i-th accent group in the phrase.

Generally, accent curves have the following properties: each accent curve corresponds to an “accent group,” where an accent group is defined as a sequence of syllables. An accent group starts with a stressed syllable and terminates either at the last unstressed syllable before the next stressed syllable or at the last unstressed syllable before a phrase boundary.

An accent group possesses an “accent type.” The accent type is one of the prosodic tags that is generated by labeling step 1230. Each accent type is associated with an “accent curve specification” that defines a subset of a set of all curves that map a finite interval of a real time axis to pitch. Generally, an accent curve specification can be broad or narrow. An example of a broad specification is a partial order over a sequence of indices, such as

“Single-peaked”: 1<2, 3<1

“Single-dipped”: 2<1, 2<3

“Rising”: 1<2

“Continuation Rise”: 1<2, 3<2, 3<4, 2<4

An example of a narrow specification is a square wave S(t) smoothed by a 2nd order filter, such as F(t) [REF FUJISAKI]. A square wave has the form:

S(t)=a if t<t0 or t>t1, and S(t)=0 otherwise. Eq. (2)

An example of an intermediately broad specification is G(w(t); s, m), where G is a Gaussian distribution having standard deviation s and mean m, and where w(t) is determined in accordance with the relationship:

w(t)=a+bt+ct² Eq. (3)

Generally, ACCENTi(t) has a value of zero outside of a time interval spanned by an accent group, and a non zero value different inside this time interval.

An “error criterion” E is minimized such that phrase curves and accent curves are jointly estimated, as indicated in step 1235. In contemplated embodiments of the invention, the “error criterion” is performed in accordance with the following exemplary un-weighted least squares relationship:

E=sum-over-t[ORIG(t)−PHRASE(t)−sum-over-iACCENTi(t)]² Eq. (4)

Next, the estimated phrase curves are combined with the estimated accent curve, as indicated in step 1240. The combination of the estimated phrase curves and the estimated accent curves are then subtracted from the original pitch contour to obtain residuals curves that correspond to an accent group (see FIG. 11), as indicated in step 1245.

All information obtained to this point is stored in memory, as indicated in step 1250. The “stored information” includes all component curves and original pitch contours, the original speech recordings, all temporal information required to synchronize the component curves, original pitch contours, labels, speech recordings, and coded representations. Optionally, signal analysis algorithms may be used to generate “coded representations” such as LPC vectors, line spectral frequency vectors, or power spectrum vectors.

To generate a desired output utterance or to synthesize output speech, a set of labels for a “desired output utterance” is obtained, as indicated in step 1255. The set of labels contains all the information that is required to retrieve the appropriate data from the stored information to create the output utterance or synthesized speech. As part of the generation of the “desired output utterance”, an utterance timing function (UTF) is used. The UTF is a mapping according to the following relationship:

UTF: {labels}−>time Eq. (5)

Here, {labels} refer to a sequence of labels for the desired output utterance. In an exemplary embodiment, for an utterance consisting of the single word PETER, the utterance timing function is:

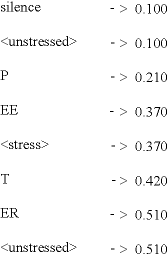

Next, data required to retrieve a pitch curve, a pitch adjustment curve and a phrase curve is obtained based on the set of labels for the “desired output utterance”, as indicated in step 1260. In certain embodiments, an operator such as a multiplication by a constant is applied to certain component curves, such as specific accent curves.

In accordance with the embodiments of the invention, a desired utterance phrase curve is calculated by way of one of several methods, such as by vertically adjusting stored phrase curve sections such that the sections intersect at the points where they converge; e.g., the utterance phrase curve is smoothed or concatenated. Alternatively, the desired utterance phrase curve is calculated by rule to create a phrase curve by way of an equation, such as the relationship in Eq. (1).

Another way to calculate the desired utterance phrase curve is to estimate parameters of the phrase curve to maximize the closeness to the stored curve sections. Here, a phrase curve is created per a similar equation, while minimizing the sum of squared differences by way of the stored curve sections. In certain embodiments, this sum is weighed in a variety of ways, such as by the relative lengths [in msec] of the respective sections or by the energy of frames within the desired utterance phrase curve.

Next, a concatenation of all speech intervals, whether coded or original, is performed, as indicated in step 1265. A time warp of the concatenated speech intervals is performed such that the concatenated speech intervals are conformed to the utterance timing function of Eq. 5, as indicated in step 1270. A time warp of the accent curves and residuals curves is performed to conform these curves to the utterance timing function, as indicated in step 1275. The time warped accent curves and residuals curves are added to the desired utterance phrase curve, as indicated in step 1280. Using the added information, the utterance is synthesized, as indicated in step 1285.

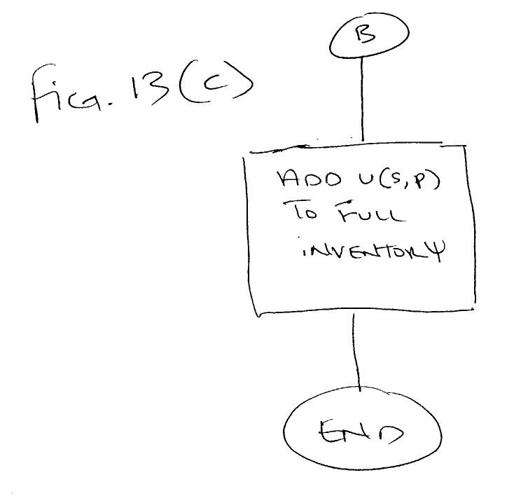

In a further aspect of the invention, the method is used to concatenate speech in a text-to-speech system. FIG. 13(a)-13(c) is a flow chart illustrating the steps of the method in accordance with the additional aspect of the invention. Here, a list of phoneme sequences S that is appropriate for a specific language is created by way of standard principles [e.g., REF], as indicated in step 1300. A list of prosodic conditions P (e.g., in terms of stress, number of syllables to the next stressed syllable, number of syllables to the next phrase boundary) is then created, as indicated in step 1305.

A list M of all combinations of the items in the lists S and P is then created, as indicated in step 1310. In accordance with the present embodiments, the list M is represented as the “product set” S×P, and items in this product set are “symbolic units,” indicated as pairs (s, p).

Next, phoneme classes, such as voiced fricatives, nasals, and vowels [REF], are defined, as indicated in step 1315. In the preferred embodiment, a phoneme sequence class is set of phoneme sequences of a given length, where all phonemes in a given position in the sequence belong to the same class. Each s in S belongs to exactly one phoneme sequence class, c. Here, c is the set of all phoneme sequence classes. An example of a phoneme sequence class is the set of triplets:

{(x, y, z)|x is a nasal, y a vowel, and z a voiced stop} Eq. (6)

For each phoneme sequence class c, at least one phoneme sequence sc is selected, as indicated in step 1320. Recordings of sc in all prosodic conditions P are then performed, as indicated in step 1325. In certain embodiments, these recordings are represented as the symbolic unit set {sc}×P.

Recordings of all other phoneme sequences in at least one common prosodic condition p1 are performed, as indicated in step 1330. Original pitch contours are then obtained, as indicated in step 1335. The component curves (e.g., phrase curve, accent curve, and residuals curves) for all original pitch contours are estimated, as indicated in step 1340.

The combination of all entities that include the recorded speech intervals and the corresponding sections of the associated component curves are determined such that an acoustic unit u(s,p) is obtained, as indicated in step 1345. Of note, the totality of all acoustic units obtained up to this point is called the “recorded inventory”.

A check is performed to determine whether u(s,p) is located within the recorded inventory, as indicated in step 1350. If u(s,p) is within the recorded inventory, then u(s,p) is added to the full inventory, as indicated in step 1355.

On the other hand, if u(s,p) is not in the recorded inventory, then an acoustic unit is developed, as indicated in step 1360. In accordance with embodiments of the invention, the speech interval, the residuals curve, the phrase curve, and the accent curve are used to construct the acoustic unit. In preferred embodiments, the speech interval is an interval from u(s,p1), the residuals curve comprises a residuals curve section from u(s,p1), the phrase curve comprises a phrase curve section from u(s,p1), and the accent curve comprises an accent curve section from u(sc,p), where s1 belongs to the same class as s.

Using the method of the invention, the removal of undesired pitch discrepancies between words output from word and phrase concatenation systems is achieved. In addition, an enhanced naturalness of the intonations in speech generated by TTS systems is obtained.

Although the invention has been described and illustrated in detail, it is to be clearly understood that the same is by way of illustration and example, and is not to be taken by way of limitation. The spirit and scope of the present invention are to be limited only by the terms of the appended claims.

What is claimed is:

1. A method for concatenating acoustic speech contours for speech synthesis, comprising the steps of:
obtaining recordings of human speech;
determining a set of target contour shape specifications based on the recorded human speech;
generating a predetermined set of output contours based on the set of target contour shape specifications;
estimating at least two component contours within the predetermined set of output contours such that each output contour is approximated by a combinational mathematical rule; and
selecting at least two component contours that are required for speech output, and
applying the combinational mathematical rule to the selected at least two component contours to generate the output contour.

2. A method for concatenating acoustic speech contours for speech synthesis, comprising the steps of:
decomposing natural speech into multiple intonation components that possess different types of information and operate at different time scales;
manipulating the multiple intonation components such that smoothness and desired levels of emphasis in the output speech is ensured; and
combining the multiple intonation components to produce synthesized speech.
